(19) United States
(12) Patent Application Publication
(10) Pub. No.: US 2020/0202383 A1
(43) Pub. Date: Jun. 25, 2020

(54) METHODS, SYSTEMS, ARTICLES OF MANUFACTURE AND APPARATUS TO DETERMINE ADVERTISEMENT CAMPAIGN EFFECTIVENESS USING COVARIATE MATCHING

(71) Applicant: The Nielsen Company (US), LLC, New York, NY (US)

(72) Inventors: Michael Sheppard, Holland, MI (US); Ludo Daemen, Duffel (BE); Edward Murphy, North Stonington, CT (US); Remy Spoentgen, Tampa, FL (US)

(21) Appl. No.: 16/230,035

(22) Filed: Dec. 21, 2018

(51) Int. Cl. G06Q 30/02; G06Q 10/06

(52) U.S. Cl. CPC G06Q 30/0243; G06Q 10/06315; G06Q 30/0244

(57) ABSTRACT

Methods, apparatus, systems and articles of manufacture are disclosed to determine advertisement campaign effectiveness using covariate matching. An example method includes segregating, by executing an instruction with a processor, a data structure into treatment groups and covariate groups, the data structure including an index of sales associated with an advertisement campaign, reducing a bias associated with the covariate groups by applying, by executing an instruction with the processor, anentropy optimization to determine a first balancing factor for a first covariate group of the covariate groups based on a geometric mean of a first subset of treatment groups associated with the covariate groups and determining, by executing an instruction with a processor, a first balanced weight for a first sale of the index of sales based on (a) the first balancing factor and (b) a first sampling weight of the first sale, the first sale associated with the first covariate group and a first treatment group of the first subset of treatment groups, the first sale associated with a first response. The example method includes determining, by executing an instruction with a processor, a first aggregate response of the first treatment group based a sum of products of (1) a first set of balanced weights associated with the first treatment group and (2) a first set of responses associated with the first treatment group, the first set of balanced weights including the first balanced weight, the first set of responses including the first response and reducing computing resource waste by modifying, by executing an instruction with a processor, computing resource allocation to the advertisement campaign based on the first aggregate response.

### FIELD OF THE DISCLOSURE

This disclosure relates generally to advertising data science, and, more particularly, to methods, systems, articles of manufacture and apparatus to determine advertisement campaign effectiveness using covariate matching.

### BACKGROUND

In recent years, advertising campaigns for products have begun using multiple media vehicles to present information to potential customers about the product. The use of multiple vehicles allows customers to be exposed to different types of advertising stimuli (e.g., radio, television, online, etc.). Advertising companies and/or other entities (e.g., audience measurement entities (AMEs), etc.), are often interested in determining the effectiveness of the different treatments (e.g., advertisement vehicles, etc.) of advertisement campaigns.

### BRIEF DESCRIPTION OF THE DRAWINGS

FIG. 1 is a schematic illustration of an example system to determine advertisement campaign effectiveness in accordance with the teachings of this disclosure.

FIG. 2 is an example implementation of the example campaign effectiveness determiner of FIG. 1.

FIGS. 3A-3I are example illustrations of data in stages of being processed by the campaign effectiveness determiner.

FIG. 4 is a flowchart representative of machine readable instructions which may be executed to implement the example campaign effectiveness determiner of FIGS. 1 and 2.

FIG. 5 is a block diagram of an example processing platform structured to execute the instructions of FIG. 3 to implement the example campaign effectiveness determiner of FIG. 1.

The figures are not to scale. In general, the same reference numbers will be used throughout the drawing(s) and accompanying written description to refer to the same or like parts.

### DETAILED DESCRIPTION

Product and service promotional activity can occur on one or more different types of media vehicles. As used herein a “media vehicle,” or more simply, a “vehicle,” refers to a specific type of media (e.g., an advertising creative or stimulus delivered or otherwise exposed to a target audience, etc.) used to deliver advertisements. Example vehicles include radio, newspaper, television, etc. Vehicles can also be defined as groups of other vehicle subsets. For example, the “digital” vehicle can refer to any combination of online advertisements which may be viewed on mobile devices, desktop computers, and/or any other suitable digital devices. An advertising campaign can use one or more vehicles to convey advertisements to a consumer. As used herein, “advertising,” “advertisements,” and/or variants thereof refers to a type of marketing effort in which a product and/or service of interest is communicated through one or more media vehicles. Advertisements can include product and/or service' information, audio and/or visual information (e.g., a song, a product image, a commercial, etc.) in an effort to expose an audience with such product and/or service information.

As used herein, a “consumer,” “consumers,” “an audience,” “an audience member,” and/or variants thereof refer to respondents (e.g., survey participants), panelists and/or more generally humans that exhibit behavior(s) that are observed in the technical field of market research. A consumer is associated with several characteristics that may be of interest to a market researcher, including, for example, age, gender, employment status, income, etc. A consumer's response to an advertisement campaign can include the amount of money spent on the product(s) after being exposed to an advertisement of the advertisement campaign.

In some examples, interested entities (e.g., advertisers, product manufacturers, etc.) attempt to determine the effectiveness of an advertisement campaign. An interested entity can treat an advertisement campaign as an observational study. In such examples, determining the casual effect of an advertisement campaign includes comparing treatment groups (e.g., groups that were exposed to advertisements, etc.) to control groups (e.g., groups that were not exposed to advertisements, etc.). In some examples, an advertisement campaign includes multiple treatment groups based on the exposure vehicle(s) associated with the advertisement campaign (e.g., a first treatment group corresponding to consumers exposed to an advertisement via a newspaper vehicle, a second treatment group corresponding to consumers exposed to an advertisement via a television vehicle, etc.). In such examples, the demographic characteristics of respondents of the observational study act as covariates. One metric of interest includes the comparative advantage of an advertisement campaign which is the change (e.g., increase or decrease) in sales associated with a specific treatment when compared to the control.

Unlike normal experimental studies (e.g., drug effectiveness testing, etc.), subjects of advertisement campaign choose to be in the treatment group or control group and are not assigned randomly by an experimenter. Accordingly, data collected by interested entities can be heavily skewed towards certain covariate demographic groups. Additionally, the non-random assignment of treatment and control groups makes determining the casual effect of an advertisement campaign difficult and can heavily bias results. Accordingly, balancing treatment and control groups can be difficult to interested entities.

Historically, market researchers operating in the technical field of market research have used several algorithms to address the problem of the non-random treatment and control groups. For example, two popular methods include propensity score matching and inverse propensity score weighting. These computer implemented models weight the data provided to balance the treatment and control groups. For example, after weighting, application of the propensity score model balances (e.g., weighs, etc.) the data to make the post-balanced number of males in the control group and the post-balanced number of males in the treatment group equal. In some examples, these methods include logit models where market researchers define a number of interactive effects between covariates. When the covariates of interest are categorical (e.g., bucketed, etc.), computational limitations often force market researchers to only model first-order effects of the advertisement campaign (e.g., the effect of the advertisement campaign on males, the effect of the advertisement campaign on teenagers, etc.) and neglect modeling higher order effects (e.g., the effect of the advertisement campaign on teenage males, etc.). Thus, in addition to burdensome computational demands, historical methods often fail to balance all covariates and rely upon the subjective judgment of a market researcher to select which groups to balance. Methods, systems, articles of manufacture and apparatus disclosed herein improve the technical field of market research by enabling the balancing of all orders of interactions between covariates by matching entire joint distributions as whole. A “joint probability distribution”, as used herein, refers to a type of probability distribution that estimates the likelihood of a particular combination of two or more covariates occurring, given a data set of including those covariates. Additionally, examples disclosed herein achieve bias and error reduction in a manner that conserves computational resources when compared to traditional techniques (e.g., propensity score techniques, etc.). An example disclosed herein includes segregating, by executing an instruction with a processor, a data structure into treatment groups and covariate groups, the data structure including an index of sales associated with an advertisement campaign, reducing a bias associated with the covariate groups by applying, by executing an instruction with the processor, an entropy optimization to determine a first balancing factor for a first covariate group of the covariate groups based on a geometric mean of a first subset of treatment groups associated with the covariate groups and determining, by executing an instruction with a processor, a first balanced weight for a first sale of the index of sales based on (a) the first balancing factor and (b) a first sampling weight of the first sale, the first sale associated with the first covariate group and a first treatment group of the first subset of treatment groups, the first sale associated with a first response. The example method further includes determining, by executing an instruction with a processor, a first aggregate response of the first treatment group based a sum of products of (1) a first set of balanced weights associated with the first treatment group and (2) a first set of responses associated with the first treatment group, the first set of balanced weights including the first balanced weight, the first set of responses including the first response and reducing computing resource waste by modifying, by executing an instruction with a processor, computing resource allocation to the advertisement campaign based on the first aggregate response.

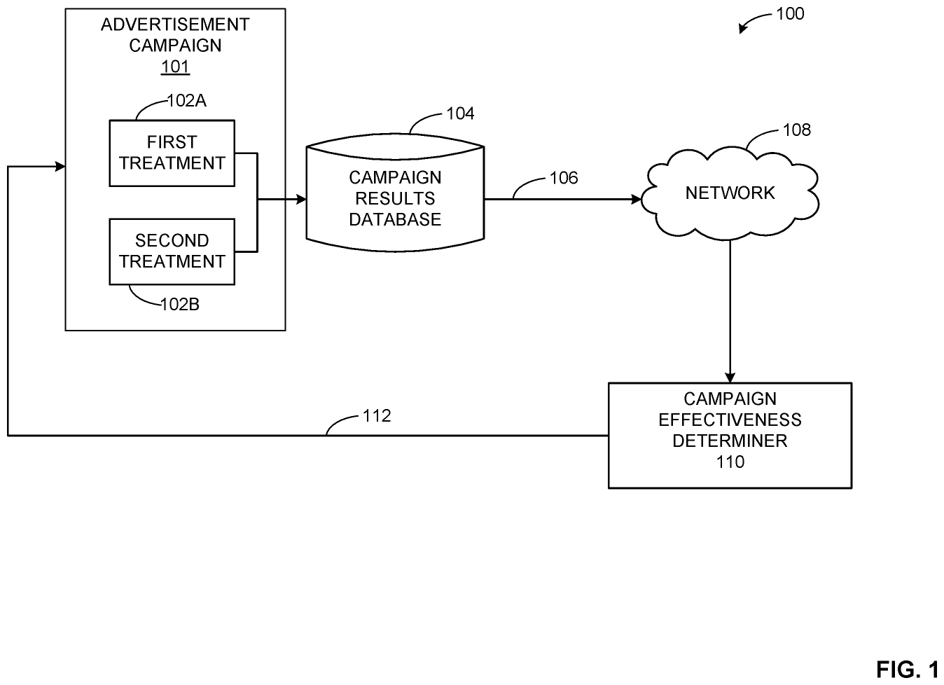

FIG. 1 is a schematic illustration of an example system 100 to determine advertisement campaign effectiveness in accordance with the teachings of this disclosure. In the illustrated example of FIG. 1, the example system 100 includes an example advertisement campaign 101 that includes at least an example first treatment data set 102A and an example treatment data set 102B. The example system 100 of FIG. 1 further includes an example campaign results database 104, an example network 108, and an example campaign effectiveness determiner 110. In the illustrated example, the campaign results database 104 outputs example campaign data 106. In the illustrated example, the campaign effectiveness determiner 110 outputs example campaign effectiveness data 112 which can act as feedback for at least one of the first treatment data set 102A and/or the second treatment data set 102B. In some examples, the campaign effectiveness determiner 110 determines the effectiveness of each treatment data set 102A, 102B and causes a change in one or more of the example treatment data set 102A, 102B to improve the effectiveness of the advertisement campaign 101. As such, the example campaign effectiveness determiner 110 improves the technical field of market research, data science and/or advertising analysis by preventing resource waste. For example, application of analyst discretion regarding a possible modeling of a combination of consumer covariates associated with the example advertising campaign 101 may result in resource waste when such combinations cause a negative and/or otherwise detrimental effect on a sales metric (e.g., a decrease in a return or investment metric, a decrease in sales, etc.).Stated differently, example campaign effectiveness determiner 110 facilities the identification and corresponding modification of the treatment data set 102A, 102B of the advertising campaign 101 in a manner that reduces waste, reduces bias and/or otherwise improves a market-related metric (e.g., unit sales, dollar sales, return or investment, etc.).

The example advertisement campaign 101 is a set of advertisements and/or promotions (e.g., a list or schedule of advertisements, advertisement types, etc.) designed to increase sales of a specific product. In the illustrated example of FIG. 1, the advertisement campaign 101 includes the example treatment data set 102A, 102B. In other examples, the advertisement campaign 101 can include any number of treatments (e.g., one, three, etc.). The example treatment data set 102A, 102B are unique groups of promotions and advertisements associated with the advertisement campaign 101. For example, the treatment data set 102A, 102B could each be associated with a specific advertisement vehicle (e.g., the first treatment data set 102A corresponds to a television vehicle, the second treatment data set 102B corresponds to a newspaper vehicle, etc.). In other examples, the treatment data set 102A, 102B correspond to unique advertisements associated with a single vehicle (e.g., the first treatment data set 102A is an advertisement featuring a celebrity endorsement, the second treatment data set 102B is an advertisement advertising a sale, etc.). In other examples, the treatment data set 102A, 102B are any suitable groupings of advertisements and/or promotions (e.g., schedules of advertisements, etc.).

The example campaign results database 104 of FIG. 1 is a database (storage, memory, etc.) that contains the campaign data 106 corresponding to sales of the product being advertised. For example, the campaign results database 104 can include each instance of a sale of the product as well as the corresponding information of the consumer that purchased the product. For example, the campaign result database 104 could contain associated covariates of each type (e.g., gender, age, etc.) and what treatment they were a part of (e.g., the first treatment data set 102A, the second treatment data set 102B, the control group, etc.). In some examples, the data in the campaign result database 104 is already weighted due to prior sampling.

In some examples, the campaign results database 104 can be associated with a specific advertisement vehicle. For example, the campaign results database 104 be associated with a television provider and provide data associated with treatments that include television advertisements. In such examples, the campaign effectiveness determiner 110 can receive and/or otherwise retrieve information from a plurality of result databases. In other examples, the campaign results database 104 is associated with the point of sale of the product (e.g., an online retailer, a brick and mortar store, etc.). In some examples, the campaign results database 104 can be provided by the advertiser associated with the advertisement campaign. In some examples, the provider of the campaign results database 104 can provide a survey to consumers of the product to determine the campaign data 106. In other examples, any other suitable method can be used to generate the campaign data 106.

Although only a single campaign results database 104 is depicted in the illustrated example of FIG. 1, the campaign effectiveness determiner 110 can retrieve and/or otherwise retrieve information from any number of providers (e.g., any number of databases, etc.). In some examples, the multiple providers are associated with a single treatment (e.g., multiple social media website databases can be associated with the digital treatment, etc.). In some examples, the campaign results database 104 provides a joint distribution of the measured campaign data 106 to campaign effectiveness determiner 110.

The example network 108 of FIG. 1 facilitates communication between the campaign results database 104 and the campaign effectiveness determiner 110. As used herein “in communication,” including variants thereof, encompasses direct communication and/or indirect communication through one or more intermediary components. In some examples, constant communication is not necessary such that selective communication at periodic, aperiodic, and/or scheduled intervals, as well as one-time events, occur. The example network 108 can be implemented by any suitable type of network (e.g., a cellular network, a wired network, the Internet, etc.). In some examples, the example network 108 can be absent (e.g., communication may occur via one or more busses, etc.). In these examples, the measured lifts and measured impression counts can be transmitted to the campaign effectiveness determiner 110 by any other suitable method (e.g., physical mail, email, etc.).

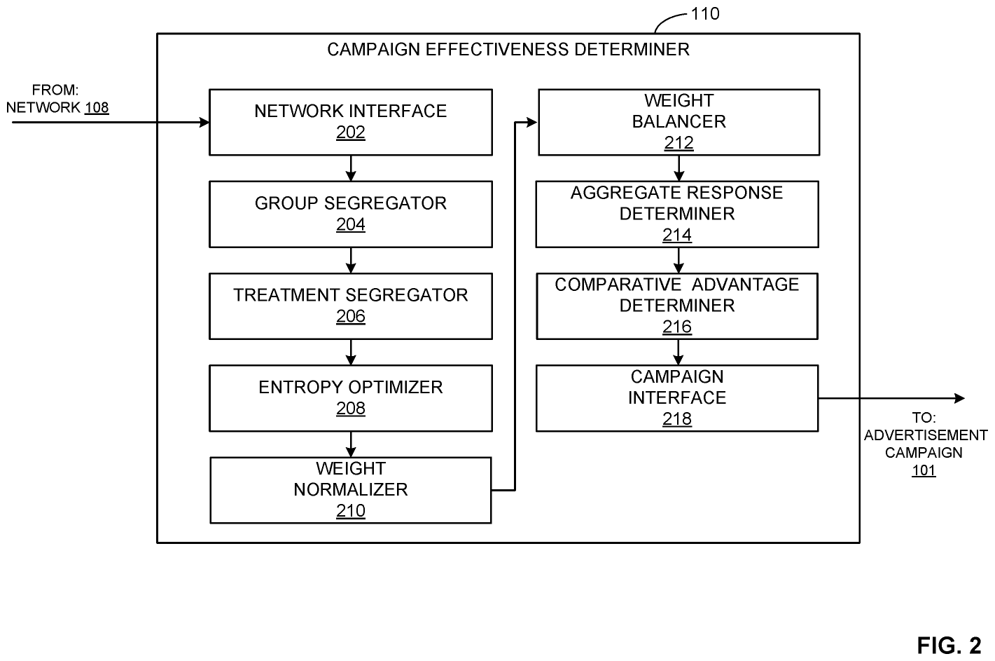

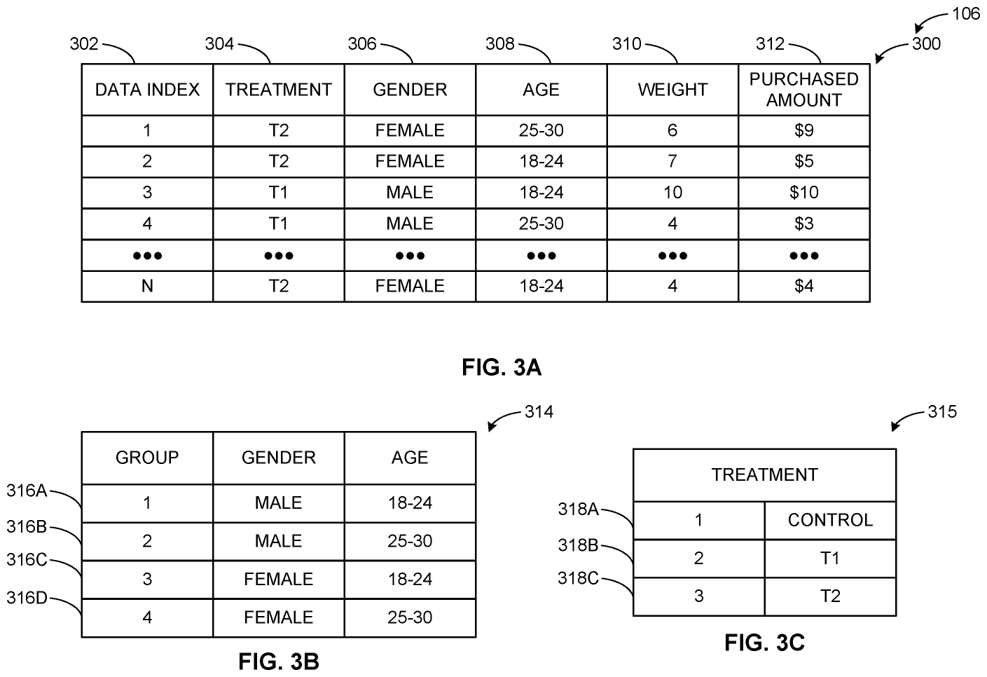

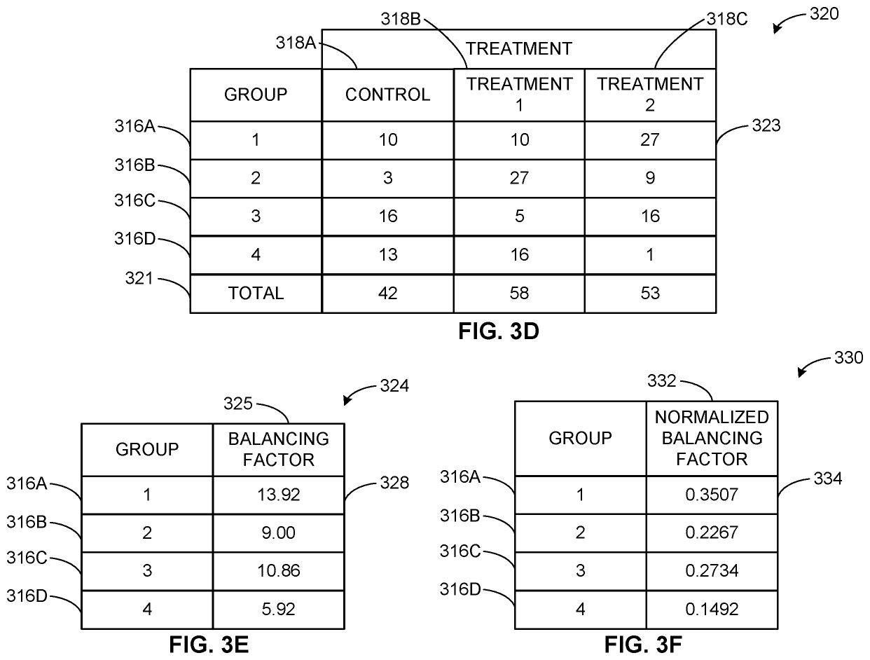

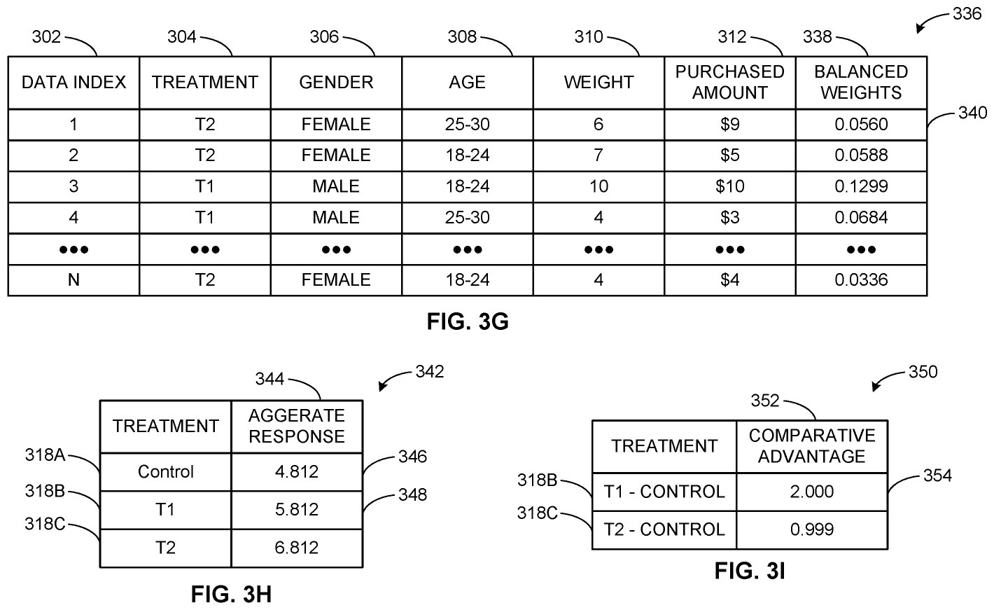

The example campaign effectiveness determiner 110 processes the campaign data 106 to determine the effectiveness of each of the treatment data set 102A, 102B. As used herein, the term “effectiveness” refers to the increase in response (e.g., sales, etc.) associated with a treatment when compared to a control. In some examples, the effectiveness of a treatment can expressed as an aggregate response or a comparative advantage. In some examples, the campaign effectiveness determiner 110 segregates the campaign data 106 into covariate groups. In some examples, the campaign effectiveness determiner 110 segregates the campaign data 106 into treatment groups. In some examples, the campaign effectiveness determiner 110 removes the covariate selection biasing using entropy optimization methods based on treatment weights as described in conjunction with FIGS. 3D-3E, Equation (2), Equation (20) and Equation (30). In some examples, the campaign effectiveness determiner 110 normalizes the group weights of the campaign data 106 to determine balanced data weights. In some examples, the campaign effectiveness determiner 110 determines the aggregate response and/or comparative advantages of each the treatment data set 102A, 102B. An example implementation of the example campaign effectiveness determiner 110 is described below in conjunction with FIG. 2.

The example campaign effectiveness determiner 110 generates the example campaign effectiveness data 112. In some examples, the campaign effectiveness data 112 can include the determined aggregate response and/or comparative advantage. In some examples, the advertisement campaign 101 is modified based by the campaign effectiveness determiner 110 on the generated campaign effectiveness data 112. For example, the campaign effectiveness data 112 can be used by the example campaign effectiveness determiner 110 to modify the allocation of resources between the first treatment data set 102A and the second treatment data set 102B. Additionally or alternatively, the campaign effectiveness data 112 can be used by the example campaign effectiveness determiner 110 to cause the allocation of resources within a treatment to be modified. In some examples, the campaign effectiveness data 112 can be used by the example campaign effectiveness determiner 110 to cause a modification to an advertisement associated with at least one of the first treatment data set 102A and/or the second treatment data set 102B (e.g., the change in the graphic of an online advertisement, change the number of advertisements per unit of time, etc.).

FIG. 2 is an example implementation of the example campaign effectiveness determiner 110 of FIG. 1. In the illustrated example of FIG. 2, the campaign effectiveness determiner 110 includes an example network interface 202, an example group segregator 204, an example treatment segregator 206, an example entropy optimizer 208, an example weight normalizer 210, an example weight balancer 212, an example aggregate response determiner 214, an example comparative advantage determiner 214, and example campaign interface 218.

In the illustrated example of FIG. 2, the example network interface 202 is a means for retrieving or a retrieving means. In the illustrated example of FIG. 2, the example group segregator 204 is a means for group-segregating or a group-segregating means. In the illustrated example of FIG. 2, the example treatment segregator 206 is a means for treatment-segregating or a treatment-segregating means. In the illustrated example of FIG. 2, the example entropy optimizer 208 is a means for bias reducing or a bias reducing means. In the illustrated example of FIG. 2, the example weight normalizer 210 is a means for weight normalizing or a weight normalizing means. In the illustrated example of FIG. 2, the example weight normalizer 210 is a means for weight normalizing or a weight normalizing means. In the illustrated example of FIG. 2, the example weight balancer 212 is a means for balanced weight determining or balanced weight determining means. In the illustrated example of FIG. 2, the example aggregate response determiner 214 is a means for aggregate response determining or aggregate response determining means. In the illustrated example of FIG. 2, the example comparative advantage determiner 216 is a means for comparative advantage determining or comparative advantage determining means. In the illustrated example of FIG. 2, the example campaign interface 218 is a means for modifying or a modifying means. As used herein, the example group-segregating means, the example treatment-segregating means, the example bias reducing means, the example weight normalizing means, the example balanced weight determining means, the example aggregate response determining means, the example comparative advantage determining means, the example modifying means are hardware.

In operation, the example network interface 202 facilitates communication between the campaign effectiveness determiner 110 and the campaign results database(s) 104 of FIG. 1. For example, the network interface 202 transmits a request to retrieve the campaign data 106 from the provider database(s) 104. An example of the campaign data 106 requested by the network interface 202 is described below in conjunction with FIG. 3A.

The example group segregator 204 of FIG. 2 determines the covariates (e.g., gender, age, etc.) of interest in the campaign data 106 and segregates the campaign data 106 based on the determined covariates. For example, the group segregator 204 can determine that the gender and age are covariates of interest. In such examples, the group segregator 204 analyzes the campaign data 106 to see what covariates are included in the data. In other examples, the group segregator 204 determines the covariates of interest based on instructions from the operating entity of the campaign effectiveness determiner 110. In other examples, the group segregator 204 determines the covariates of interest by any other suitable techniques.

In some examples, the group segregator 204 creates covariate groups based on each combination of covariates. For example, the group segregator 204 can determine that there are two gender covariates (e.g., male, female, etc.) and two age covariates (e.g., ages 18-24, ages 25-30, etc.). In such examples, the group segregator 204 can create four groups corresponding to each combination of covariates (e.g., a first group corresponding to males 18-24, a second group corresponding to females 18-24, a third group corresponding to males 25-30, a fourth group corresponding to females 25-30, etc.). In such examples, the group segregator 204 categorizes each index in the campaign data 106 according to such groups. In some examples, indexes of the campaign data 106 unassociated with any identified group are ignored by the campaign effectiveness determiner 110. An example of the generated groups created by the group segregator 204 is described below in conjunction with FIG. 3B.

The example treatment segregator 206 analyzes the campaign data 106 to determine what treatments are presented in the campaign data 106. For example, the treatment segregator 206 can determine that sales associated with the first treatment data set 102A, the second treatment data set 102B, and neither the treatment data sets 102A, 102B (e.g., the control data set, etc.) are presented in the campaign data 106. In such examples, the treatment segregator 206 identifies each present treatment and categorizes each index of the campaign data 106 based on the associated treatment. An example of the identified treatments created by the treatment segregator 206 is described below in conjunction with FIG. 3C. In some examples, the treatment segregator 206 can further determine the corresponding weights associated with each group-treatment combination. In some examples, after being processed by the group segregator 204 and the treatment segregator 206, each data index (e.g., a portion of campaign data 106 associated with a single sale, etc.) of the campaign data 106 is now associated with a specific group-treatment combination.

The example entropy optimizer 208 processes the data to determine the group weight across all treatments using entropy optimization principles. For example, the entropy optimizer 208 sums the weight of each data index across each group-treatment combination. In some examples, the entropy optimizer 208 then processes each group using entropy optimization for each group across all treatments. In such examples, the entropy optimizer 208 takes a geometric mean of the group-treatment combination across all treatments. In such examples, the entropy optimizer 208 generates an unnormalized weight for each group. Example outputs of the entropy optimizer 208 are described below in conjunction with FIGS. 3D and 3E.

The example weight normalizer 210 then normalizes each weight determined by the entropy optimizer 208. For example, the weight normalizer 210 sums the weights determined by the entropy optimizer 208 and then divides each determined weight by the sum of the weights. An example output of the weight normalizer 210 is described below in conjunction with FIG. 3F.

The example weight balancer 212 determines a balanced weight for each data index of the campaign data 106 using the normalized weight generated by the weight normalizer 210. For example, the weight balancer 212 normalizes the weight of each index by multiplying the normalized group weight by the ratio of unit weight (e.g., the pre-sampled weight of index in the campaign data 106) to the total weight associated with group-treatment combination. In some examples, the balancing factors determined by the weight balancer 212 are balanced for the entire joint distribution. In some examples, the balancing factors for each group-treatment combination is summed. An example output of the weight balancer 212 is described below in conjunction with FIG. 3G.

The aggregate response determiner 214 determines the aggregated response to each treatment using the balanced weights determined by the weight balancer 212. For example, the aggregate response determiner 214 determines the balanced response of each data index and then sums each index according to the treatment associated with the index. For example, the aggregate response determiner determines the aggregate response to the first treatment data set 102A by sum the balanced response (e.g., the unbalanced response multiplied by the balancing factor) associated with each data index associated with first treatment data set 102A. An example output of the aggregate response determiner 214 is described below in conjunction with FIG. 3H.

The example comparative advantage determiner 216 determines the comparative advantage of each treatment. For example, the comparative advantage determiner 216 determines the comparative advantage of the first treatment data set 102A by subtracting the aggregate response to the control by the aggregate response to first treatment data set 102A. Similarly, the comparative advantage determiner 216 determines the comparative advantage of the second treatment data set 102B by subtracting the aggregate response to the control from the aggregate response to the second treatment data set 102B. An example output of the comparative advantage determiner 216 is described below in conjunction with FIG. 3H.

The example campaign interface 218 modifies treatment resource allocation based on the determined aggregate response(s) and/or comparative advantage(s). For example, the campaign interface 218 causes a change in resource allocation between the treatment data set 102A, 102B. In other examples, the campaign interface 218 causes a change in resource allocation within at least one treatment of the example treatment data set 102A, 102B.

FIG. 3A depicts an example configuration of the example campaign data 106 analyzed into example data structure 300 by the example network interface 202. The example data structure 300 of FIG. 3A includes an example data index column 302, an example treatment column 304, an example first covariate column 306, an example second covariate column 308, an example data weight column 310 and an example response column 312. In the illustrated example, the data index column 302 includes “N” data indexes, each one corresponds to a specific sale associated with the product of the advertisement campaign 101. In some examples, each index of the data index column 302 corresponds to a specific consumer that purchased a product associated with the advertisement campaign 101.

The treatment column 304 indicates which treatment group the sale is associated with. In the illustrated example of FIG. 3A, the data structure 300 includes sales associated with three treatment groups, namely the control group (“CONTROL”), the first treatment group 102A (“T1”) and the second treatment group 102B (“T2”). In some examples, the data structure 300 can have any other number of treatment groups.

The first covariate column 306 of FIG. 3A indicates which covariate the consumer associated with a specific index is associated. In the illustrated example of FIG. 3A, the first covariate column 306 corresponds to the gender covariates. Accordingly, each index of the data structure 300 is associated with the “MALE” covariate and the “FEMALE” covariate. In other examples, any other suitable covariate is reflected in the first covariate column 306.

The second covariate column 308 of FIG. 3A indicates which covariate the consumer associated with a specific index is associated. In the illustrated example of FIG. 3A, the second covariate column 308 corresponds to age covariates. Accordingly, each index of the data structure 300 is associated with the “18-24” covariate and the “25-30” covariate. In other examples, any other suitable covariate can be included in the second covariate column 308. Although the illustrated example only depicts the covariates columns 306, 308, the data structure 300 can include any other number of covariates columns (e.g., employment status, income, etc.).

The data weight column 310 of FIG. 3A indicates the weight assigned to each data index of the data structure 300 prior to being analyzed by the campaign effectiveness determiner 110. For example, the values of the data weight column 310 can be assigned (e.g., assigned by one or prior analysis and/or data acquisition, etc.) during a prior sampling operation. In other examples, the data weight column 310 could equally weigh each data index (e.g., each value of the weight column is “1”, etc.). The example purchase amount 312 indicates the amount of sales associated with each index of the data structure 300. In the illustrated example of FIG. 3A, the values in the response column 312 are an amount in dollars. In other examples, the values in the response column 312 can be quantities (e.g., the amount of a product sold, etc.). In some examples, the response column 312 is representative of the response associated with each data index.

FIG. 3B depicts an example data structure 314 generated by the example group segregator 204. The example data structure 314 represents an example configuration of the example campaign data 106 configured into the example data structure 314 after being processed by the group segregator 204. In the illustrated example of FIG. 3B, the group segregator 204 generates an example first covariate group 316A, an example second group 316B, an example covariate third group 316C and an example fourth group 316D based on the first covariate column 306 and the second covariate column 308. The example first covariate group 316A corresponds to data indexes with “MALE” in the first covariate column 306 and “18-24” in the second covariate column 308. The example second group 316B corresponds to data indexes with “MALE” in the first covariate column 306 and “25-30” in the second covariate column 308. The example third covariate group 316C corresponds to data indexes with “FEMALE” in the first covariate column 306 and “18-24” in the second covariate column 308. The example fourth group 316D corresponds to data indexes with “FEMALE” in the first covariate column 306 and “25-30” in the second covariate column 308. In some examples, the group segregator 204 creates the covariate groups that the campaign effectiveness determiner 110 will be balancing to enable the determination of effectiveness of the advertising campaign 101.

FIG. 3C depicts an example data structure 315 generated by the example group segregator 204. The example data structure 315 represents an example configuration of the example campaign data 106 arranged and/or generated into the example data structure 315 after being processed by the treatment segregator 206. For example, the treatment segregator 206 analyzes the campaign data 106 and determines the treatment group associated with each data index (e.g., the treatment column 304 of the data structure 300, etc.). In the illustrated example of FIG. 3C, the treatment segregator 206 segregates the campaign data 106 according to an example first treatment group 318A, an example second treatment group 318B and an example third treatment group 318C. The example first treatment group 318A corresponds to the data associated with the control group. The example second treatment group 318B corresponds to the data associated with the first treatment data set 102A. The example third treatment group 318C corresponds to the data associated with the second treatment data set 102B. In some examples, the treatment segregator 206 creates the treatment groups to allow the operation of the entropy optimizer 208.

FIG. 3D depicts an example data structure 320 generated by the example group segregator 204. The example data structure 320 represents an example configuration of the example campaign data 106 configured into the example data structure 320 by the entropy optimizer 208 which includes the total row 321. In the illustrated example of FIG. 3D, the data structure 320 is organized by treatment group (e.g., the treatment groups 318A, 318B, 318C, etc.) and covariate group (e.g., the covariate groups 316A, 316B, 316C, 316D, etc.). In the illustrated example of FIG. 3D, the entropy optimizer 208 determines each value in the data structure 320 by summing of the pre-sampled weights (e.g., the values of the data weight column 310, etc.) of each data index associated with that treatment group and the covariate group. For example, the value of cell 323 corresponds to the sum of each data index associated with the control group 318A and covariate group 316A. In the illustrated example of FIG. 3D, the total row 321 includes values which are the sum of treatment group 318A, 318B and 318C across all covariate groups 316A, 316B, 316C. The example total row 321 includes the block 323 which is the sum of the value of each coverage group value (e.g., the block 323, etc.) across the control group 318A.

FIG. 3E depicts an example data structure 324 generated by the example group segregator 208. The example data structure 324 represents an example configuration of the example campaign data 106 configured into the example data structure 324 by the entropy optimizer 208 which includes the balancing factor column 325. In the illustrated example of FIG. 3E, the entropy optimizer 208 calculates the balancing factor for each covariate group 316A, 316B, 316C, 316D. For example, the entropy optimizer 208 calculates the geometric mean of each covariate group across all treatment groups 318A, 318B, 318C to determine the balancing factors. In other examples, the values of the balancing factor column are calculated using any other suitable technique. For example, the value in cell 328, the balancing factor corresponding to the first covariate group 316A, is determined by the entropy optimizer 208 based on the geometric mean of summed weights of the control group 318A, the second treatment group 318B and the example third treatment group 318C associated with the first covariate group 316A.

FIG. 3F depicts an example data structure 330 generated by the example weight normalizer 210. The example data structure 330 represents an example configuration of the example campaign data 106 configured into the example data structure 330 by the weight normalizer 210 which includes the normalized balancing factor column 332. In the illustrated example of FIG. 3F, the weight normalizer 210 calculates the normalized balancing factor for each covariate group 316A, 316B, 316C, 316D based on the balancing factor associated with the respective covariate group (e.g., the values of the balancing factor column 325, etc.) and the total sum of the balancing factors (e.g., summing the values of the balancing factor column 325). For example, the value of block 334 is the ratio of the value of block 328 and the sum of each value in the balancing factor column 325.

FIG. 3G depicts an example data structure 336 generated by the example weight balancer 212. The example data structure 336 represents an example configuration of the example campaign data 106 configured into the example data structure 336 by the weight balancer 212 which includes the example balanced weight column 338. In the illustrated example, the values of the balanced weight column are determined by the weight balancer 212 based on the values of the data weight column 310, the values of the data structure 320 and the values of the normalized balancing factor column 322. For example, the value of block 340 is calculated by weight balancer 212 by calculating the ratio of the weight associated with the first data index and the value of the data structure 320 corresponding to the first data index. The determined ratio is then multiplied by the corresponding value of the normalized balancing factor column 332. In the illustrated example, the values of the balanced weight column 338 represent the optimally calculated weight for each index of the data index column 302 and are determined using entropy optimization techniques.

FIG. 3H depicts an example data structure 342 generated by the example aggregate response determiner 214. The example data structure 342 represents an example configuration of the example campaign data 106 configured into the example data structure 342 by the aggregate response determiner 214 which includes the example aggregate response column 344. The example aggregate response column 344 includes an example first block 346 and an example second block 348. The values of the aggregate response column correspond to the response to the respective treatment groups 318A, 318B, 318C by consumers of the product of the advertisement campaign 101. The values of the aggregate response column 344 are calculated by summing the product of each response and balanced weights of each data index associated with that treatment group. For example, the value of block 346 corresponds to sum of the products of the balanced weights (e.g., the values of the balanced weight column 338) and the response (e.g., the values of response column 312) associated with each data index associated with the control group 318A.

FIG. 3I depicts an example data structure 350 generated by the example comparative advantage determiner 216. The example data structure 350 represents an example configuration of the example campaign data 106 configured into the example data structure 350 by the comparative advantage determiner 216 which includes the example aggregate response column 352. The example aggregate response column 352 includes block 354. The comparative advantage determiner 216 determines the comparative advantage of the treatment group 318B, 318C by the subtracting the aggregate response associated with that treatment group by the aggregate response to the control group. For example, the value of block 354 (e.g., the comparative advantage of the second treatment group 318B, etc.) is determined based on the value of block 346 and the value of block 348. In some examples, the comparative advantage of each treatment group corresponds to the effectiveness of the treatment data set 102A, 102B. In some examples, the comparative advantage(s) generated by the comparative advantage determiner 216 can be used to identify which, if any, treatments of the advertising campaign 101 increase sales of the product. While an example manner of implementing the campaign effectiveness determiner 110 of FIGS. 1 and 2 is illustrated in FIG. 1-3I, one or more of the elements, processes and/or devices illustrated in FIG. 1-3I may be combined, divided, re-arranged, omitted, eliminated and/or implemented in any other way. Further, the example network interface 202, the example group segregator 204, the example treatment segregator 206, the example entropy optimizer 208, the example weight normalizer 210, the example weight balancer 212, the example aggregate response determiner 214, the example comparative advantage determiner 214, the example campaign interface 218 and/or, more generally, the example campaign effectiveness determiner 110 of FIGS. 1 and 2 may be implemented by hardware, software, firmware and/or any combination of hardware, software and/or firmware. Thus, for example, any of the example network interface 202, the example group segregator 204, the example treatment segregator 206, the example entropy optimizer 208, the example weight normalizer 210, the example weight balancer 212, the example aggregate response determiner 214, the example comparative advantage determiner 214, the example campaign interface 218 and/or, more generally, the example campaign effectiveness determiner 110 of FIGS. 1 and 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network interface 202, the example group segregator 204, the example treatment segregator 206, the example entropy optimizer 208, the example weight normalizer 210, the example weight balancer 212, the example aggregate response determiner 214, the example comparative advantage determiner 214, the example campaign interface 218 is/are hereby expressly defined to include a non-transitory computer readable storage device or storage disk such as a memory, a digital versatile disk (DVD), a compact disk (CD), a Blu-ray disk, etc. including the software and/or firmware. Further still, the example campaign effectiveness determiner 110 of FIGS. 1-2 may include one or more elements, processes and/or devices in addition to, or instead of, those illustrated in FIGS. 1 and 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

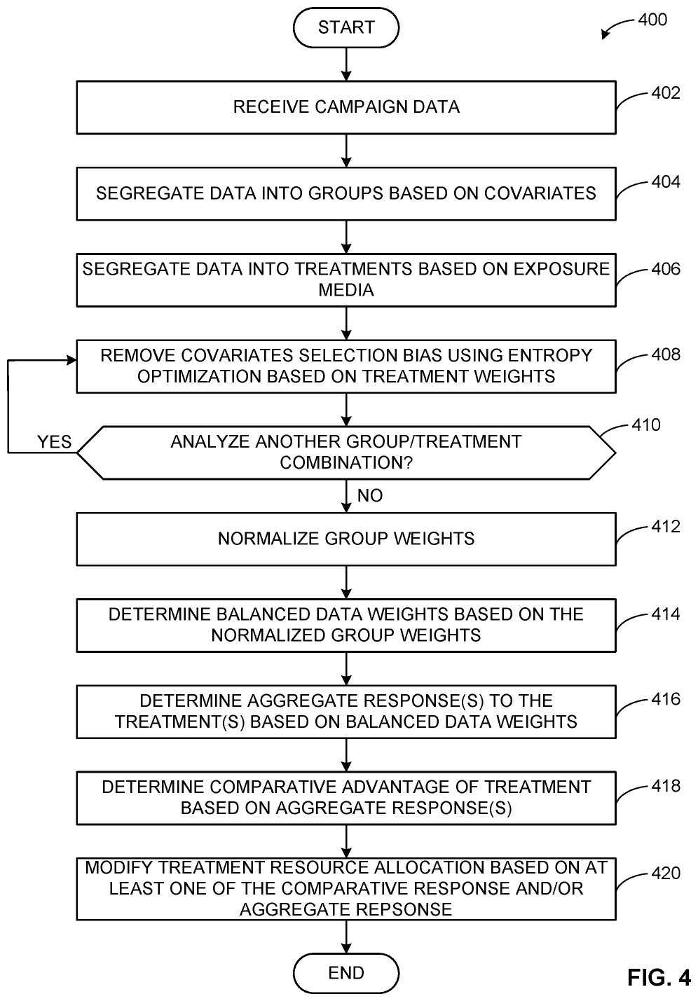

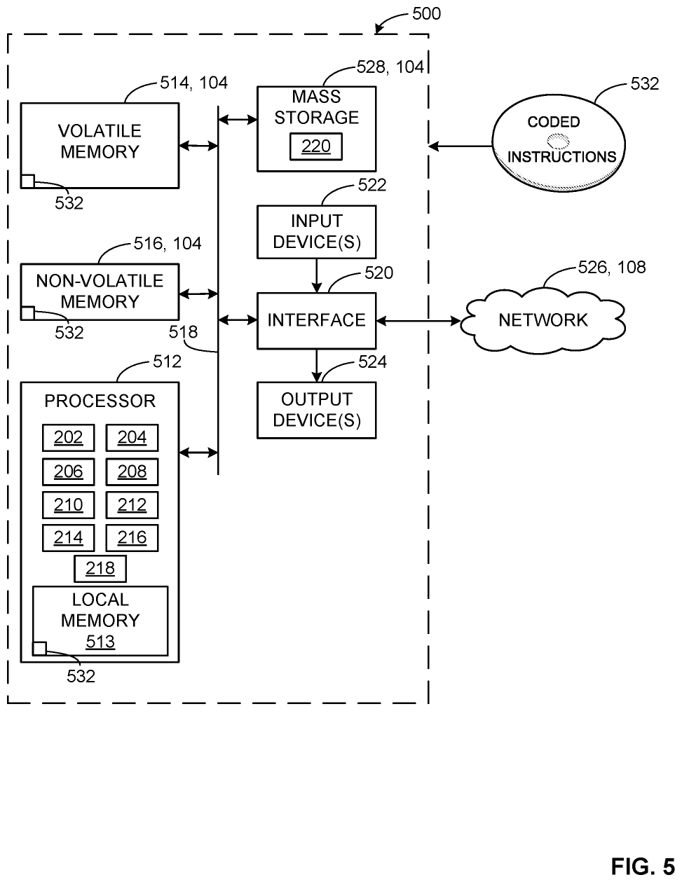

A flowchart representative of example hardware logic, machine readable instructions, hardware implemented state machines, and/or any combination thereof for implementing the campaign effectiveness determiner 110 of FIG. 2 is shown in FIG. 4. The machine readable instructions may be an executable program or portion of an executable program for execution by a computer processor such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIG. 4, many other methods of implementing the example campaign effectiveness determiner 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example process of FIG. 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program 400 of FIG. 4 includes block 402. At block 402, the network interface 202 receives campaign data. For example, the network interface 202 requests the campaign data 106 from the campaign results database 104. In some examples, the network interface 202 transforms the data into a form readable by the campaign effectiveness determiner 110. For example, the network interface 202 converts the campaign data 106 into the data structure 300.

At block 404, the group segregator 204 segregates the data into groups based on covariates. For example, the group segregator 204 determines each covariate of interested in the campaign data 106 and segregate the campaign data 106 according to each unique grouping of covariates. For example, if the campaign data 106 includes the gender covariates “MALE” and “FEMALE” and the age covariates “18-24” and “25-30,” the group segregator 204segregates the data into covariate groups 316A, 316B, 316C, 316C the data structure 314 of FIG. 3B.

At block 406, the treatment segregator 206 segregates data into treatments based on exposure media. For example, the treatment segregator 206 segregates the data into unique treatment groups based on the what treatment(s) are contained with the campaign data 106. For example, if the campaign data 106 is associated with the first treatment data set 102A and the second treatment data set 102B, the treatment segregator 206 segregates the campaign data 106 into the treatment groups 318A, 318B, 318C of the example data structure 314 of FIG. 3C.

At block 408, the entropy optimizer 208 removes covariates selection bias using entropy optimization based on treatment weights. For example, the entropy optimizer 208remotes covariate selection bias based on entropy optimization methods. In some examples, the sum the weights associated with each treatment group and covariate groups as illustrated in the data structure 320 of FIG. 3D. In such examples, the entropy optimizer determines the geometric mean of each covariate group across all treatment groups, as illustrated in the data structure 324 of FIG. 3E. In other examples, the entropy optimizer 208calculates the balancing factors by any other appropriate means. At block 410, the entropy optimizer 208 determines if another group-treatment group is to be analyzed. If another group/treatment combination is to be analyzed the program 400 returns to block 408. If another group/treatment combination is to be analyzed, the program 400 advances to block 412.

At block 412, the weight normalizer 210 normalizes group weight. For example, the weight normalizer 210 calculates the normalized balancing factors for each covariate group based on the associated balancing factors calculated by the entropy optimizer 208 for all groups and the sum of all the balancing factors calculated by the weight normalizer 210. In other examples, the weight normalizer 210 calculates the normalized balancing factor by any other appropriate means. For example, the weight normalizer 210 creates the data structure 330 of FIG. 3F.

At block 414, the weight balancer 212 determines the balanced data weights based on the normalized group weights. For example, the weight balancer 212 calculates the balanced data weights for data index of the campaign data 106 based on the normalized weight factor calculated by the weight normalizer 210. In some examples, the weight balancer 212 creates specific balanced weights associated with each data index of the campaign data 106. In other examples, the weight balancer 212 creates specific balanced weights for each covariate group (e.g., the covariate groups 316A, 316B, 316C). For example, the weight balancer 212 creates the data structure 336 of FIG. 3D.

At block 416, the aggregate response determiner 214 determines the aggregate response to the treatments based on the balanced data weights. For example, for each treatment group identified by the treatment segregator 206, the aggregate response determiner 214 sums the products of each response and balanced weight for each data index of the campaign data 106 associated with that respective treatment group. For example, the aggregate response determiner 214 creates the data structure 342 of FIG. 3H.

At block 418, the comparative advantage determiner 216 determines the comparative advantage of the treatment based on the determined aggregate responses determined by the aggregate response determiner 214. For example, the comparative advantage determiner 216 determines the comparative advantage of the treatment groups 318B, 318C by subtracting the control group aggregate response from the respective aggregate responses of the treatment groups. In some examples, the comparative advantage determiner 216 creates the data structure 350 of FIG. 3I.

At block 420, the campaign interface 218 modifies treatment resource allocation based on at least one of the comparative response and/or aggregate response. For example, the campaign interface 218 changes the allocation of computing and/or budget resources to the advertisement campaign 101 of FIG. 1. In some examples, the campaign interface 218 causes a modification of computing resources between the first treatment data set 102A and the second treatment data set 102B. In some examples, the campaign interface 218 causes the advertisements and/or promotions associated with the first treatment data set 102A and/or the second treatment data set 102B.

FIG. 5 is a block diagram of an example processor platform 1000 structured to execute the instructions of FIG. 4 to implement the campaign effectiveness determiner 110 of FIGS. 1 and 2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example network interface 202, the example group segregator 204, the example treatment segregator 206, the example entropy optimizer 208, the example weight normalizer 210, the example weight balancer 212, the example aggregate response determiner 214, the example comparative advantage determiner 216, the example campaign interface 218.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIG. 4 may be stored in the mass storage device 528, in the volatile memory 514, in the non-volatile memory 516, and/or on a removable non-transitory computer readable storage medium such as a CD or DVD.

From the foregoing, it will be appreciated that example methods, systems, apparatus and articles of manufacture have been disclosed can be applied to any observational experiment with treatments and controls. For example, consider an observational experiment with a single treatment group and a single control. Observed covariates could be some combination of age, gender, location, income, etc. While the results of this observation experiment may not cover the entire theoretical joint distribution, there may be enough samples that the observed unique combinations of covariates in the treatment group matches the same observed unique combinations in the control group. However, there may be different distributions of the covariates in the treatment group and control group. For example, consider the following treatment and control groups:

T: AAABBC with YT=[9, 10, 10, 5, 9, 9]

C: ABBBDD with YD=[2, 2, 5, 10, 4, 6] (1)

In the in illustrated example of Equation (1), T is an example treatment group, C is an example control group, A represents a sample with a first combination of covariates (e.g., 18-24 Male in Florida, etc.), B represents a sample with a second combination of covariates (e.g., 18-24 Female in Florida, etc.), D represents a sample with a third combination of covariates (e.g., 25-30 Female in Florida, etc.), YT are example responses (e.g., the money spent, etc.) associated with respective treatment samples and YD are example responses associated with respective control samples. In the illustrated example of Equation (1), the treatment group (T) includes 3 samples with the A covariate combination, 2 samples with the B covariate combination and 1 sample with the C covariate combination in the treatment group. In the illustrated example of Equation (1), the control group includes 1 sample with the A covariate combination, 3 samples with the B combination and 2 samples with the C covariate combination. Determining the optimal weighting (e.g., by the campaign effectiveness determiner 110, etc.) associated with the above groups includes weighting of the combinations proportionally to the geometric mean of the number of specific combinations between the control group and treatment group.

The optimal weighting associated with an observational study with single treatment group (e.g., T) and a single control group (e.g., C) is determined by the campaign effectiveness determiner 110 by maximizing the entropy across both probability distributions (e.g., (1) the probability distribution associated the distribution of samples into the covariate groups, and (2) the probability distribution associated with the distribution of samples into treatment groups, etc.). This solution is implemented by the example campaign effectiveness determiner 110 in a manner consistent with example Equation (2):

$$maximize H = {\sum }_{k = 1}^{2} {\sum }_{j = 1}^{J} {n}_{j}^{( k )} ( - {w}_{j}^{( k )} log ( {w}_{j}^{( k )} ) ) \qquad ( 2 )$$

In the illustrated example of Equation (2), k is the treatment group (e.g., k =1 is the control group, k=2 is the treatment group, etc.), j is the covariate group (e.g., j=1 is A, j=2 is B, etc.), nⱼ^{(k)} is the number of samples associated with the jth covariate group of the kth treatment group, and wⱼ^{(k)} is the optimal weighting associated with samples associated with the jth covariate group of the kth treatment group. Additionally, due to multiple summations involved in example Equation (2), the solution weights are specific to individual samples with each combination and not the combination as a collective group. Equation (2) is subject to the following constraints:

$$\begin{matrix}{\sum }_{j = 1}^{J} {n}_{j}^{( k )} {w}_{j}^{( k )} = 1 \\ ∀ k = \{ 1 , 2 \} & ( 3 ) \\ {n}_{j}^{( 1 )} {w}_{j}^{( 1 )} = {n}_{j}^{( 2 )} {w}_{j}^{( 2 )} \\ ∀ j = 1 , … , J & ( 4 )\end{matrix}$$

Example Equation (3) indicates that post weight combination should have a weighting that sums to one hundred percent. Equation (3) is valid because the weigh average is a per-sample measure. Example Equation (4) indicates that post-weighted combination for each treatment-control group should be equal.

Ignoring Equation (3), the solution to Equation (2) is subject only to Equation (4). In this example, the solution to Equation (2) for each covariate group is:

$$\begin{matrix}{n}_{1}^{( 1 )} {\tilde{w}}_{1}^{( 1 )} = {( {n}_{1}^{( 1 )} {w}_{1}^{( 2 )} )}^{\frac{1}{2}} = {n}_{1}^{( 2 )} {\tilde{w}}_{1}^{( 2 )} \\ ⋮ & ( 5 ) \\ {n}_{J}^{( 1 )} {\tilde{w}}_{J}^{( 1 )} = {( {n}_{J}^{( 1 )} {w}_{J}^{( 2 )} )}^{\frac{1}{2}} = {n}_{J}^{( 2 )} {\tilde{w}}_{J}^{( 2 )} & ( 6 )\end{matrix}$$

where \tilde{w}ⱼ^{(k)} is the weighted solution to Equation (2) without being subjected to Equation (3) for the jth covariate group of the kth treatment (e.g., the balancing factors of the balancing factor column 324, etc.) Accordingly, as described above, \tilde{w}ⱼ^{(k)} equals the geometric mean of the counts. Using the values of sample counts associated with each of the covariate groups (e.g., A, B, C) of Equation (1), the following solution can be determined:

$$\begin{matrix}{( {n}_{A}^{( 1 )} {n}_{A}^{( 2 )} )}^{\frac{1}{2}} = {( 3 * 1 )}^{\frac{1}{2}} = 1.7321 & ( 7 a ) \\ {( {n}_{B}^{( 1 )} {n}_{B}^{( 2 )} )}^{\frac{1}{2}} = {( 3 * 2 )}^{\frac{1}{2}} = 2.4495 & ( 7 b ) \\ {( {n}_{C}^{( 1 )} {n}_{C}^{( 2 )} )}^{\frac{1}{2}} = {( 1 * 2 )}^{\frac{1}{2}} = 1.4142 & ( 7 c )\end{matrix}$$

Equations (7a), (7b), (7c) can be used to determine the post-weight counts associated with each of the covariate groups. Accordingly, the values determined in equations (7a), (7b) and (7c) can be used by the entropy optimizer 208 to determine the \tilde{w}ⱼ^{(k)} associated with each of the covariate-treatment groups using example Equation (6):

$$\begin{matrix}{\tilde{w}}_{A}^{( 1 )} = \frac{{( {n}_{A}^{( 1 )} {n}_{A}^{( 2 )} )}^{\frac{1}{2}}}{{n}_{A}^{( 1 )}} = \frac{1.7321}{1} = 1.7321 & ( 8 a ) \\ {\tilde{w}}_{B}^{( 1 )} = \frac{{( {n}_{B}^{( 1 )} {n}_{B}^{( 2 )} )}^{\frac{1}{2}}}{{n}_{B}^{( 1 )}} = \frac{2.4495}{3} = 0.8165 & ( 8 b ) \\ {\tilde{w}}_{C}^{( 1 )} = \frac{{( {n}_{C}^{( 1 )} {n}_{C}^{( 2 )} )}^{\frac{1}{2}}}{{n}_{C}^{( 1 )}} = \frac{1.4142}{2} = 0.7071 & ( 8 c ) \\ {\tilde{w}}_{A}^{( 2 )} = \frac{{( {n}_{A}^{( 1 )} {n}_{A}^{( 2 )} )}^{\frac{1}{2}}}{{n}_{A}^{( 2 )}} = \frac{1.7321}{3} = 0.5774 & ( 8 d ) \\ {\tilde{w}}_{B}^{( 2 )} = \frac{{( {n}_{B}^{( 1 )} {n}_{B}^{( 2 )} )}^{\frac{1}{2}}}{{n}_{B}^{( 2 )}} = \frac{2.4495}{2} = 1.2247 & ( 8 e ) \\ {\tilde{w}}_{C}^{( 2 )} = \frac{{( {n}_{C}^{( 1 )} {n}_{C}^{( 2 )} )}^{\frac{1}{2}}}{{n}_{C}^{( 2 )}} = \frac{1.4142}{1} = 1.4142 & ( 8 f )\end{matrix}$$

Using the values determined in equations (8a)-(8f), the population average treatment effect (ATE) can be determined by the aggregate response determiner 214 multiplying the response (e.g., the values associated with YT and YC) associated with each with unnormalized balancing factor:

$${ATE}_{pop} = ( 9 * 0.5774 + 10 * 0.5774 + 5 * 1.12247 + 9 * 1.2247 + 9 * 1.4142 ) - ( 2 * 1.7321 + 2 * 0.8165 + 5 * 0.8165 + 10 * 0.8165 + 4 * 0.7071 + 6 * 0.7071 ) = 22.2025 \qquad ( 9 )$$

Similarly, the pre-sample average treatment effect can be determined by the weight population:

$${ATE}_{per\_sample} = \frac{{ATE}_{pop}}{\sum {( {n}_{j}^{( 1 )} {n}_{j}^{( 2 )} )}^{\frac{1}{2}}} = \frac{22.2025}{5.5958} = 3.9677 \qquad ( 10 )$$

The solution of Equation (2) constrained by both Equation (3) and Equation (4) begins by defining:

$$\begin{matrix}{c}_{j} = {( {n}_{j}^{( 1 )} {n}_{j}^{( 2 )} )}^{\frac{1}{2}} & ( 11 ) \\ {c}_{◯} = {\sum }_{j = 1}^{J} {c}_{j} & ( 12 ) \\ {r}_{j} = \frac{{c}_{j}}{{c}_{◯}} & ( 13 )\end{matrix}$$

where cⱼ is the post-weighted count for each covariate group, c_{●} is the sum of the post-weighted count, and rᵢ is the normalized post-weighted count (e.g., corresponds to the values of the values of the normalized column 332, etc.). Subsisting Equation (12) into Equation (5) and Equation (6) yields the following equation:

nⱼ⁽¹⁾\tilde{w}ⱼ⁽¹⁾=c₁=n₁⁽²⁾\tilde{w}₁⁽²⁾ (14)

nⱼ⁽¹⁾\tilde{w}ⱼ⁽¹⁾=cⱼ=nⱼ⁽²⁾\tilde{w}ⱼ⁽²⁾ (15)

The normalized post-weighted counts can be determined by normalizing Equation (15) and Equation (16) by c_{●}:

n₁⁽¹⁾w₁⁽¹⁾=r₁=n₁⁽²⁾w₁⁽²⁾ (16)

nⱼ⁽¹⁾wⱼ⁽¹⁾=rⱼ=nⱼ⁽²⁾wⱼ⁽²⁾ (17)

where wⱼ^{(k)} is the normalized weighted solution to Equation (2) constrained by Equation (3) and Equation (4) for the jth covariate group of the kth treatment. Accordingly, each normalized weighted solution can be solved by the weight normalizer 210. For example, w₃⁽²⁾ can be determined and/or otherwise calculated by the weight normalizer 210 by solving Equation (17) and Equation (18):

$$\begin{matrix}{w}_{3}^{( 2 )} = \frac{{r}_{3}}{{n}_{3}^{( 2 )}} \\ = ( \frac{1}{{n}_{3}^{( 2 )}} ) ( \frac{{c}_{3}}{{c}_{◯}} ) \\ = ( \frac{1}{{n}_{3}^{( 2 )}} ) \\ ( \frac{{( {n}_{3}^{( 1 )} {n}_{3}^{( 2 )} )}^{\frac{1}{2}}}{{( {n}_{1}^{( 1 )} {n}_{1}^{( 2 )} )}^{\frac{1}{2}} + {( {n}_{1}^{( 1 )} {n}_{2}^{( 2 )} )}^{\frac{1}{2}} + {( {n}_{3}^{( 1 )} {n}_{3}^{( 2 )} )}^{\frac{1}{2}}} )\end{matrix} \qquad ( 18 )$$

The other normalized weighted solutions can be similarly determined by equations similar to Equation (19).

In some examples, Equation (2) is modified to account for more than two treatment groups:

$$maximize H = {\sum }_{k = 1}^{K} {\sum }_{j = 1}^{J} {n}_{j}^{( k )} ( - {w}_{j}^{( k )} log ( {w}_{j}^{( k )} ) ) \qquad ( 19 )$$

where K is the total number of treatment groups. When K is equal to 2, equation (19) can be simplified to Equation (2). Similar to Equation (2), Equation (19) is subjected to following constraints:

$$\begin{matrix}subject to {\sum }_{j = 1}^{J} {n}_{j}^{( k )} {w}_{j}^{( k )} = 1 \\ ∀ k = \{ 1 , … , K \} & ( 20 ) \\ {n}_{j}^{( 1 )} {w}_{j}^{( 1 )} = … = {n}_{j}^{( K )} {w}_{j}^{( K )} \\ ∀ j = 1 , … , J & ( 21 )\end{matrix}$$

The solution to Equation (20) subject to Equation (19) subject to Equation (21) and not Equation (20) is analogous to the solution to Equation (2) described in Equation (5) and Equation (6). This solution can be described in a manner consistent with equations (22) and (23):

$$\begin{matrix}{n}_{1}^{( 1 )} {\tilde{w}}_{1}^{( 1 )} = [ … ] = {n}_{1}^{( K )} {\tilde{w}}_{1}^{( K )} = {( {\prod }_{k = 1}^{K} {n}_{1}^{( k )} )}^{\frac{1}{K}} \\ ⋮ & ( 22 ) \\ {n}_{J}^{( 1 )} {\tilde{w}}_{J}^{( 1 )} = [ … ] = {n}_{J}^{( K )} {\tilde{w}}_{J}^{( K )} = {( {\prod }_{k = 1}^{K} {n}_{J}^{( k )} )}^{\frac{1}{K}} & ( 23 )\end{matrix}$$

This solution can be simplified by that the K'th root of a product of K numbers is the geometric mean of that set:

$${c}_{j} = {( {\prod }_{k = 1}^{K} {n}_{J}^{( k )} )}^{\frac{1}{K}} = \sqrt[K]{{n}_{j}^{( 1 )} … {n}_{j}^{( K )}} \qquad ( 24 )$$

where cⱼ is the geometric mean of nⱼ^{(k)}. Accordingly, Equation (22) and Equation (23) can be simplified in a manner consistent with Equations (26) and (27):

n₁⁽¹⁾\tilde{w}₁⁽¹⁾=[ . . . ]=n₁^{(K)}\tilde{w}₁^{(K)}=c₁ (25)

nⱼ⁽¹⁾\tilde{w}ⱼ⁽¹⁾=[ . . . ]=n₁^{(K)}\tilde{w}₁^{(K)}=cⱼ (26)

Accordingly, the unnormalized weights can be determined by the entropy optimizer 208 using Equation (25) and Equation (26). The normalized weights can be determined using the definitions described in Equation (13):

n₁⁽¹⁾w₁⁽¹⁾=[ . . . ]=n₁^{(K)}w₁^{(K)}=rⱼ (27)

nⱼ⁽¹⁾wⱼ⁽¹⁾=[ . . . ]=nⱼ^{(K)}wⱼ^{(K)}=rⱼ (28)

Thus, each normalized weighted solution can be solved. For example, w₁⁽¹⁾ can be determined by solving Equation (27) and Equation (28):

$$\begin{matrix}{w}_{2}^{( 1 )} = \frac{{r}_{2}}{{n}_{2}^{( 1 )}} \\ = ( \frac{1}{{n}_{2}^{( 1 )}} ) ( \frac{{c}_{2}}{{c}_{◯}} ) \\ = ( \frac{1}{{n}_{2}^{( 1 )}} ) \\ ( \frac{{( {n}_{2}^{( 1 )} {n}_{2}^{( 2 )} {n}_{2}^{( 3 )} )}^{\frac{1}{3}}}{{( {n}_{1}^{( 1 )} {n}_{1}^{( 2 )} {n}_{1}^{( 3 )} )}^{\frac{1}{3}} + {( {n}_{2}^{( 1 )} {n}_{2}^{( 2 )} {n}_{2}^{( 3 )} )}^{\frac{1}{2}}} )\end{matrix} \qquad ( 29 )$$

In the examples described in FIGS. 3A-3I, the values of the samples (e.g., the data index of the campaign data 106, etc.) are associated with a predetermined sampling weight even if they belong to the same covariate group. This pre-sampling weight can be defined in a manner consistent with example equation (30):

$${n}_{j}^{( k )} = {\sum }_{i = 1}^{{I}_{j}^{( k )}} {d}_{ij}^{( k )} \qquad ( 30 )$$

Where i is the sample number associated with j'th group of the k'th treatment, I is the total number of samples associated with the j'th group of the k'th treatment, and dᵢⱼ^{(k)} is the sampling weight of the i'th sample of the j'th group of the k'th treatment. Equation (30) indicates that the total unit count for the j'th group of the k'th treatment is the sum of the respective unit weights. Accordingly, Equation (2) can be similarly modified to take individual sampling weights into account:

$$maximize D = {\sum }_{k = 1}^{2} {\sum }_{j = 1}^{J} {\sum }_{i = 1}^{{I}_{j}^{( k )}} ( {w}_{ij}^{( k )} log ( \frac{{w}_{j}^{( k )}}{{d}_{ij}^{( k )}} ) ) \qquad ( 31 )$$

Equation (31) is similar Equation (2) with the addition of the unequal weighting of each individual sample. Similar to Equation (2), Equation (31) is subjected to:

$$\begin{matrix}{\sum }_{j = 1}^{J} {\sum }_{i = 1}^{{I}_{j}^{( k )}} {w}_{ij}^{( k )} = 1 \\ ∀ k = \{ 1 , … , K \} & ( 32 ) \\ {\sum }_{i = 1}^{{I}_{j}^{( k )}} {w}_{ij}^{( 1 )} = … = {\sum }_{i = 1}^{{I}_{j}^{( k )}} {w}_{ij}^{( K )} \\ ∀ j = 1 , … , J & ( 33 )\end{matrix}$$

Like Equation (3), Equation (32) indicates that the total post-balanced weights sum to 100%. Like Equation (4), Equation (33) indicates that each of the treatment groups weights for each covariate group. The solution to equation (31) can be shown to be:

$${w}_{ij}^{( k )} = ( \frac{{d}_{ij}^{( k )}}{{n}_{j}^{( k )}} ) {r}_{j} \qquad ( 34 )$$

From the foregoing, it will be appreciated that example methods, apparatus, systems and articles of manufacture have been disclosed that determine advertisement campaign effectiveness using covariate matching. The disclosed methods, apparatus and articles of manufacture improve the efficiency of using a computing device by allowing resources of an advertising campaign to be more efficiently allocated. Further, the disclosed example allow the productivity of an individual treatment to be determined. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to allocate advertising campaign resources, the apparatus comprising:
a group segregator to segregate a data structure into covariate groups, the data structure including an index of sales associated with an advertisement campaign;
a treatment segregator to segregate the data structure into treatment groups;
an entropy optimizer to reduce a bias associated with the covariate groups by applying an entropy optimization to determine a first balancing factor for a first covariate group of the covariate groups based on a geometric mean of a first subset of treatment groups associated with the covariate groups;
a weight balancer to determine a first balanced weight for a first sale of the index of sales based on (a) the first balancing factor and (b) a first sampling weight of the first sale, the first sale associated with the first covariate group and a first treatment group of the first subset of treatment groups, the first sale associated with a first response;
an aggregate response determiner to determine a first aggregate response of the first treatment group based a sum of products of (1) a first set of balanced weights associated with the first treatment group and (2) a first set of responses associated with the first treatment group, the first set of balanced weights including the first balanced weight, the first set of responses including the first response; and
a campaign interface to reduce computing resource waste by modifying computing resource allocation to the advertisement campaign based on the first aggregate response.

2. The apparatus as defined in claim 1, further including a network interface to retrieve the data structure from a results database, the results database associated with an advertisement provider associated with the advertisement campaign.

3. The apparatus as defined in claim 1, wherein:
the entropy optimizer is to determine a second balancing factor for a second covariate group of the covariate groups based on a geometric mean of a second subset of treatment groups associated with the covariate groups; and
the weight balancer is to determine a second balanced weight for a second sale of the index of sales based on (a) the second balancing factor and (b) a second sampling weight of the second sale, the second sale associated with the second covariate group and a first treatment group of the first subset of treatment groups, the second sale associated with a second response, the first set of balanced weights further including the second balanced weight, the first set of responses further including the second response.

4. The apparatus as defined in claim 3, wherein:
the weight balancer is to determine a third balanced weight for a third sale of the index of the sales based (1) the first balancing factor and (b) a third sampling weight of the third sale, the third sale associated with the first covariate group and a second treatment group of the first subset of treatment groups, the third sale associated with a third response; and
the aggregate response determiner is to determine a second aggregate response of the second treatment group based a sum of products of (1) a second set of balanced weights associated with the second treatment group and (2) a second set of responses associated with the second treatment group, the second set of balanced weights including the third balanced weight, the second set of responses including the first response.

5. The apparatus as defined in claim 4, wherein the second treatment group is a control group, the control group associated with consumers who were not exposed to the advertisement campaign.

6. The apparatus as defined in claim 4, further including a comparative advantage determiner to determine a first comparative advantage corresponding to the first treatment group by determining a difference between the first aggregate response and the second aggregate response.

7. The apparatus as defined in claim 1, wherein the entropy optimizer is to reduce the bias associated with the covariate groups by balancing all orders of interactions between the covariate groups.

8.-14. (canceled)

15. A non-transitory computer readable storage medium, comprising instructions, which when executed cause a processor to at least:
segregate a data structure into treatment groups and covariate groups, the data structure including an index of sales associated with an advertisement campaign;
reduce a bias associated with the covariate groups by applying an entropy optimization to determine a first balancing factor for a first covariate group of the covariate groups based on a geometric mean of a first subset of treatment groups associated with the covariate groups;
determine a first balanced weight for a first sale of the index of sales based on (a) the first balancing factor and (b) a first sampling weight of the first sale, the first sale associated with the first covariate group and a first treatment group of the first subset of treatment groups, the first sale associated with a first response;
determine a first aggregate response of the first treatment group based a sum of products of (1) a first set of balanced weights associated with the first treatment group and (2) a first set of responses associated with the first treatment group, the first set of balanced weights including the first balanced weight, the first set of responses including the first response; and
reduce computing resource waste by modifying, by executing an instruction with the processor, computing resource allocation to the advertisement campaign based on the first aggregate response.

16. The storage medium as defined in claim 15, wherein the instructions, when executed, cause the processor to retrieve the data structure from a results database, the results database associated with an advertisement provider associated with the advertisement campaign.

17. The storage medium as defined in claim 15, wherein the instructions, when executed, cause the processor to:
determine a second balancing factor for a second covariate group of the covariate groups based on a geometric mean of a second subset of treatment groups associated with the covariate groups; and
determine a second balanced weight for a second sale of the index of sales based on (a) the second balancing factor and (b) a second sampling weight of the second sale, the second sale associated with the second covariate group and a first treatment group of the first subset of treatment groups, the second sale associated with a second response, the first set of balanced weights further including the second balanced weight, the first set of response further including the second response.

18. The storage medium as defined in claim 17, wherein the instructions, when executed, cause the processor to:
determine a third balanced weight for a third sale of the index of the sales based (1) the first balancing factor and (b) a third sampling weight of the third sale, the third sale associated with the first covariate group and a second treatment group of the first subset of treatment groups, the third sale associated with a third response; and
determine a second aggregate response of the second treatment group based a sum of products of (1) a second set of balanced weights associated with the second treatment group and (2) a second set of responses associated with the second treatment group, the second set of balanced weights including the third balanced weight, the second set of responses including the first response.

19. The storage medium as defined in claim 18, wherein the second treatment group is a control group, the control group associated with consumers who were not exposed to the advertisement campaign.

20. The storage medium as defined in claim 18, wherein the instructions, when executed, cause the processor to determine a first comparative advantage corresponding to the first treatment group by determining a difference between the first aggregate response and the second aggregate response.

21. An apparatus to allocate advertising campaign resources, the apparatus comprising:
means for group-segregating to segregate a data structure into covariate groups, the data structure including an index of sales associated with an advertisement campaign;
means for treatment-segregating to segregate the data structure into treatment groups;
means for bias reducing to reduce a bias associated with the covariate groups by applying an entropy optimization to determine a first balancing factor for a first covariate group of the covariate groups based on a geometric mean of a first subset of treatment groups associated with the covariate groups;
means for balanced weight determining to determine a first balanced weight for a first sale of the index of sales based on (a) the first balancing factor and (b) a first sampling weight of the first sale, the first sale associated with the first covariate group and a first treatment group of the first subset of treatment groups, the first sale associated with a first response;
means for aggregate response determining to determine a first aggregate response of the first treatment group based a sum of products of (1) a first set of balanced weights associated with the first treatment group and (2) a first set of responses associated with the first treatment group, the first set of balanced weights including the first balanced weight, the first set of responses including the first response; and
means for modifying to reduce computing resource waste by modifying computing resource allocation to the advertisement campaign based on the first aggregate response.

22. The apparatus as defined in claim 21, further including a means for retrieving to retrieve the data structure for a results database, the results database associated with an advertisement provider associated with the advertisement campaign.

23. The apparatus as defined in claim 21, wherein:
the bias reducing means is to determine a second balancing factor for a second covariate group of the covariate groups based on a geometric mean of a second subset of treatment groups associated with the covariate groups; and
the balanced weight determining means is to determine a second balanced weight for a second sale of the index of sales based on (a) the second balancing factor and (b) a second sampling weight of the second sale, the second sale associated with the second covariate group and a first treatment group of the first subset of treatment groups, the second sale associated with a second response, the first set of balanced weights further including the second balanced weight, the first set of response further including the second response.

24. The apparatus as defined in claim 23, wherein:
the balanced weight determining means is to determine a third balanced weight for a third sale of the index of the sales based (1) the first balancing factor and (b) a third sampling weight of the third sale, the third sale associated with the first covariate group and a second treatment group of the first subset of treatment groups, the third sale associated with a third response; and
the aggregate response determining means is to determine a second aggregate response of the second treatment group based a sum of products of (1) a second set of balanced weights associated with the second treatment group and (2) a second set of responses associated with the second treatment group, the second set of balanced weights including the third balanced weight, the second set of responses including the first response.

25. The apparatus as defined in claim 24, wherein the second treatment group is a control group, the control group associated with consumers who were not exposed to the advertisement campaign.

26. The apparatus as defined in claim 24, further including a means for comparative advantage determining to determine a first comparative advantage corresponding to the first treatment group by determining a difference between the first aggregate response and the second aggregate response.

27. The apparatus as defined in claim 21, wherein the bias reducing means is to reduce the bias associated with the covariate groups by balancing all orders of interactions between the covariate groups.
